(19) United States
(12) Patent Application Publication
(10) Pub. No.: US 2004/0261756 A1
(43) Pub. Date: Dec. 30, 2004

(54) Rotary engine

(76) Inventor: Jung Kuang Chou, Panchiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/900,192

(22) Filed: Jul. 28, 2004

Related U.S. Application Data
(63) Continuation-in-part of application No. 10/392,859, filed on Mar. 21, 2003.

(51) Int. Cl. F02B 53/04; F02D 13/04

(52) U.S. Cl. 123/228

(57) ABSTRACT

A rotary engine includes a round wheel, which has a shaft pivoted on a frame to provide kinetic force during rotating, wherein the round wheel is provided with a plurality of axial pockets, each of which has a leading plane. At least one block is located at a lateral side of the wheel, which keeps stable contact with the side surface of the wheel by use of elastic force provided by a spring mounted on a screw. The block has an intake chamber and a combustion chamber, which are opposite to pockets of the wheel to form quasi cylinders. At least two rollers are fixed on the frame to support and maintain the block in stable. An action force, which can be produced when fuel is burn and exploded in the combustion chamber, pushes the wheel to rotate continuously for output efficient kinetic force for utilization.

This application is a continuation-in-part of U.S. application Ser. No. 10/392,859 filed on 21 Mar. 2003, which has claimed priority on Taiwanese application filed on 3 Apr. 2002.

### FIELD OF THE INVENTION

The present invention relates to a rotary engine, and especially to an invented and novel apparatus having absolute new structure for providing continuous horsepower as an efficient engine.

### BACKGROUND OF THE INVENTION

There are various kinds of engines for providing kinetic force in different mechanic apparatus. Each engine is designed for a certain purpose in utilizing a related machine with a specific way to supply the horsepower. It is popular that most land vehicles use reciprocating piston engines, which are characterized in that their torques are normal in low rotating speed. The known reciprocating piston engine generally must have a suitable clearance between the piston and the cylinder thereof for rotation, thereby, it should be cooled to be controlled at the state of low-temperature rotation to prevent from strain by expansion and contracting by heating and cooling, the total heat consumption thereof is about 60% of the total amount of fuel, and the effective rate of use is only about 30%.

Further, an intermittent intake system is not easy in controlling the mixture ratio of air with fuel, a low combustion temperature is subject to air contamination, and each time the cylinder has a larger explosion amount, higher noise, larger vibration, more complicated control, and relatively, its structure is heavier, bigger and more consolidated. By virtue that explosion has some limitations, the internal diameter of the cylinder is perfectly not larger than 15 cm; hence a gasoline engine with larger horsepower mostly is composed of multiple cylinders, the performance of acceleration of it is inferior, it is added with mixed gas once every one or two turns of rotation, the amount that can be added is limited, and is hard to elevate the combustion temperature for increasing efficiency.

### SUMMARY OF THE INVENTION

The present invention is to provide a rotary engine getting rid of the limitation of a conventional piston engine, which can avoid the defects of the limitation by the low temperature rotation, the intermittent gas intake and discharging to elevate the combustion temperature for increasing efficiency. Now, accompanying with the following drawings, the character of the present invention will be described here and after.

### BRIEF DESCRIPTION OF THE DRAWINGS

FIG. 1 is a perspective view showing a rotary engine according to the present invention.

FIG. 2 is an exploded perspective view of FIG. 1 showing parts of the engine.

FIG. 3 is a cross-sectional plan view showing the contact plane of FIG. 2.

FIG. 4 is a top cross-sectional plan view of FIG. 1.

FIGS. 5 to 7 are plan views of FIG. 4 showing acting processes according to the present invention.

FIG. 8 is a cross-sectional plan view showing a modified embodiment according to the present invention.

FIG. 9 is a perspective view showing an exemplary embodiment of FIG. 8.

### DETAILED DESCRIPTION OF THE PREFERRED EMBODIMENT

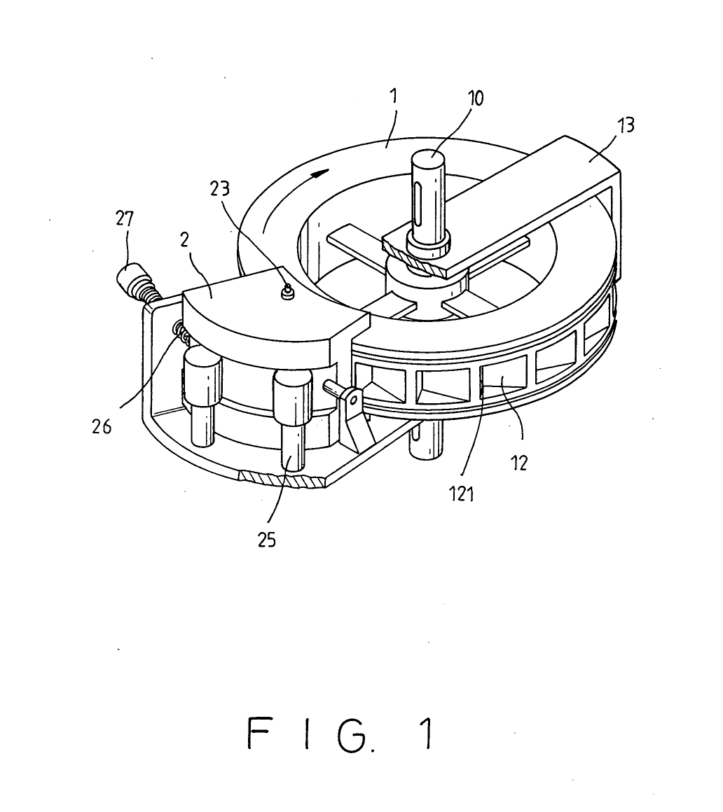

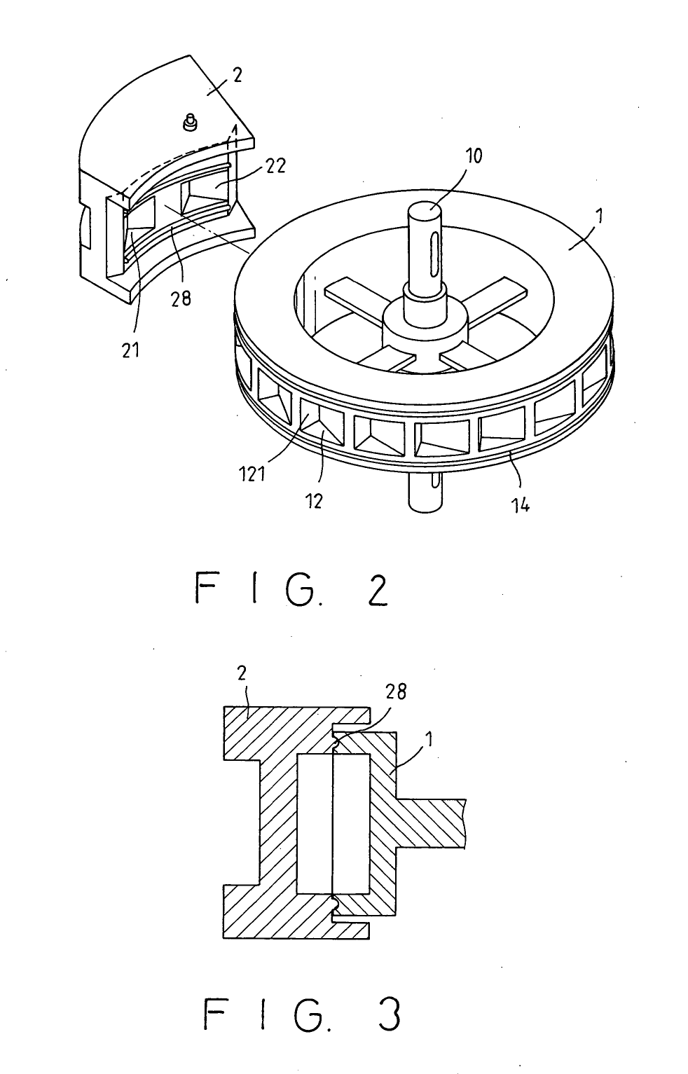

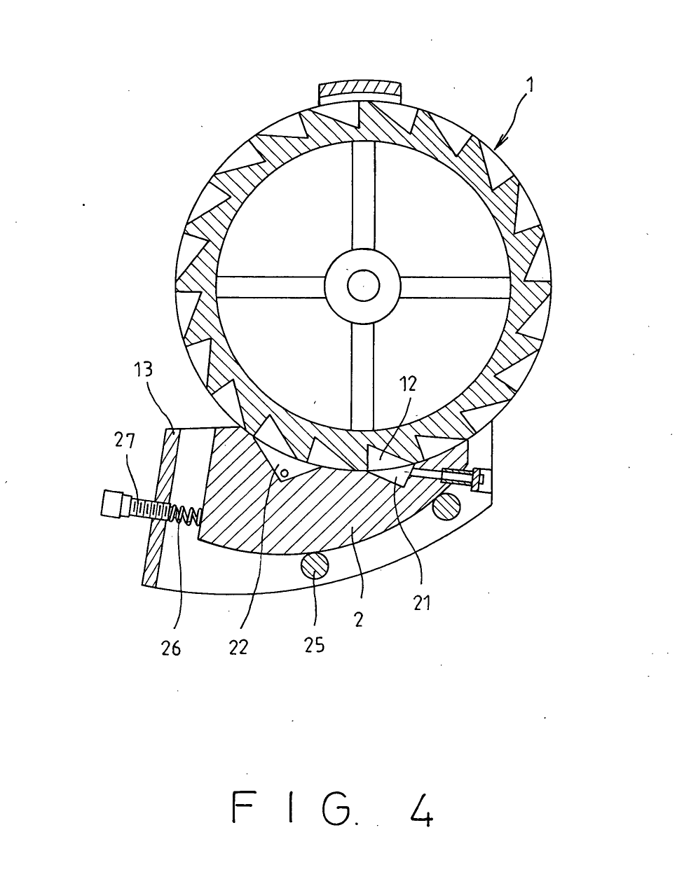

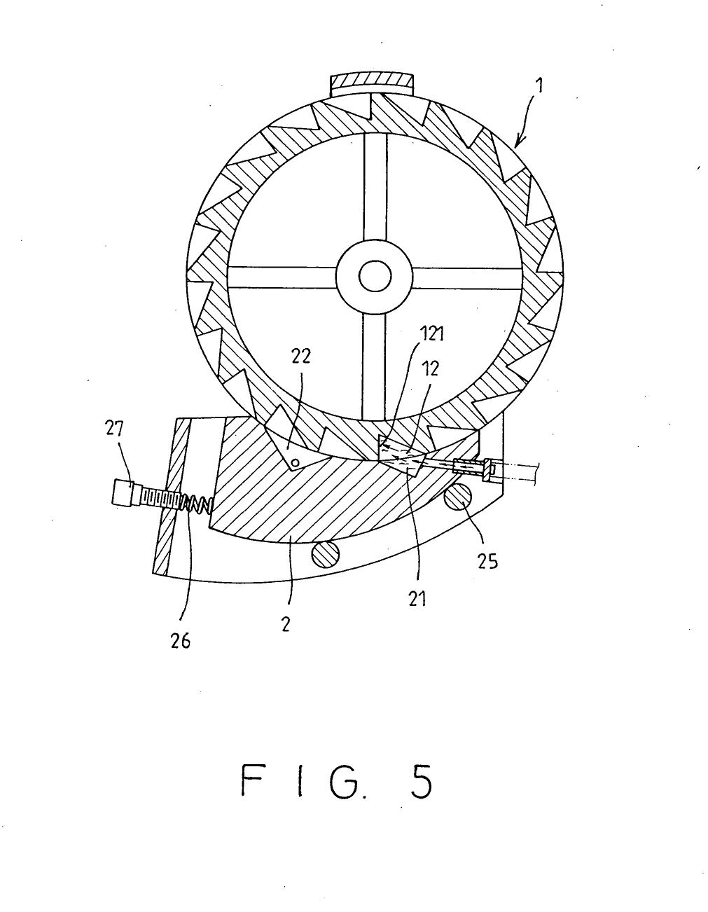

Please referring to FIG. 1 to 4, the present invention includes a round wheel (1), of which a shaft (10) is pivoted on a frame (13) to provide kinetic force during rotating. The round wheel (1) is provided with a plurality of axial pockets (12) being capable of any suitable configuration and having a leading plane (121). At least one block (2) is located at a lateral side of the wheel (1) to keep stable contact with the side surface of the wheel (1) by use of elastic force provided by a spring (26) mounted on a screw (27) connected on the frame (13), wherein the block (2) is provided with a convex ring (28) for fitting with concave portion (14) formed on the wheel (1), as shown in FIG. 2. The block (2) is also provided with an intake chamber (21) and a combustion chamber (22), which are opposite to pockets (12) of the wheel (1) to form quasi cylinders. At least two rollers (25) are fixed on the frame (13) to support and maintain the block (2) in stable.

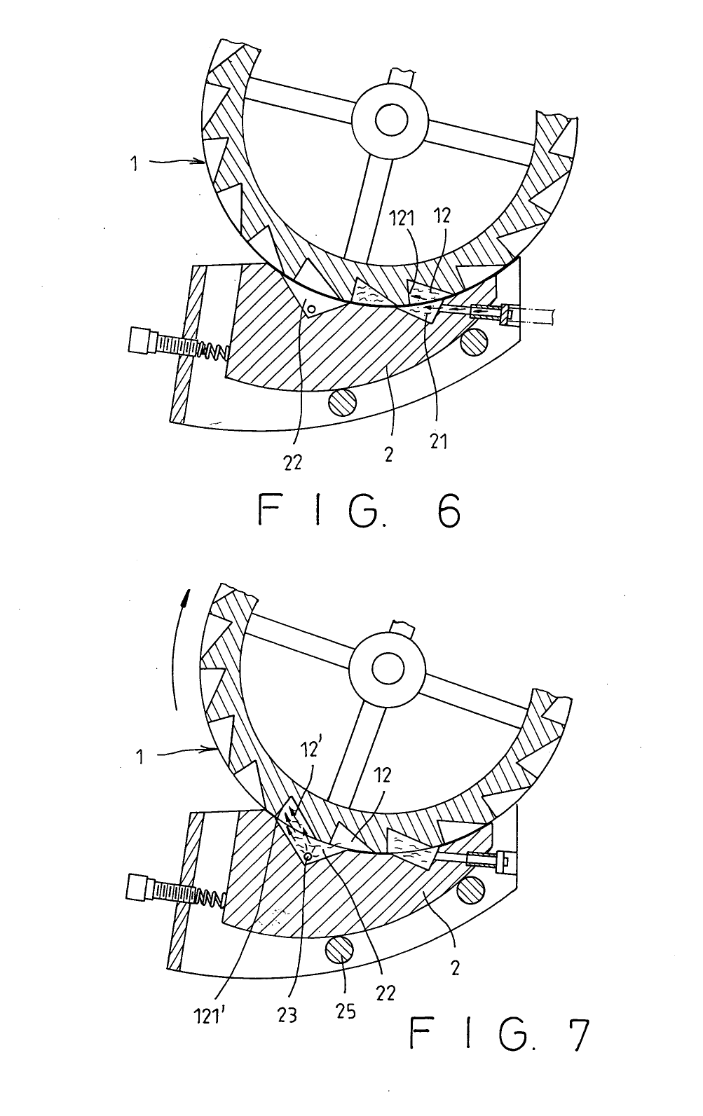

In processing, when mixed fuel is injected into the intake chamber (21) and a related pocket (12), as shown in FIGS. 5 to 7, a pressure of the direct flow can motivate the wheel (1) to stare rotating. As the said pocket (12) with mixed fuel is moved to communicate with the combustion chamber (22), the fuel will be burn quickly by a spark plug (23) provided thereof. An explosion is occurred and an expansion force is produced. Since the block (2) is kept in stable by the roller (25), the instant expansion force will be acting on the leading plane (121) of the pocket (12) to accelerate the wheel (1) rotating because it is the easiest way for releasing the pressure of the explosion gas. In more detailed description, referring to FIG. 7, as soon as the said pocket (12) is moved to the communicated position, the mixed fuel flows into the combustion chamber (22) and is burn quickly that produces high pressured air including H₂O and CO₂ to fulfill within the combustion chamber (22) and the previous pocket (12′), and then the high pressure air is capable of being exhausted as the leading plane (121′) of the previous pocket (12′) moves away from the edge of the block (1) that pushes the wheel to rotate and releases the pressure at a later time. In other words, when the expansion force is produced in the closed space formed by the combustion chamber (22) and the pocket (12), the block (2) is in stable while the wheel (1) is rotating that makes most reacting force push the leading plane (121) of the pocket (12) for rotating the wheel (1) quickly. It can be understood that by use of said repeated processes of explosion, the wheel (1) rotates and outputs the continuous kinetic force for utilization efficiently. And by virtue that the combustion keeps in higher temperature of combustion, it can get the same effect when in a lower ratio of compression; but the rotation speed of the engine is smaller, the ratio of compression can be changed to adjust the rotation speed.

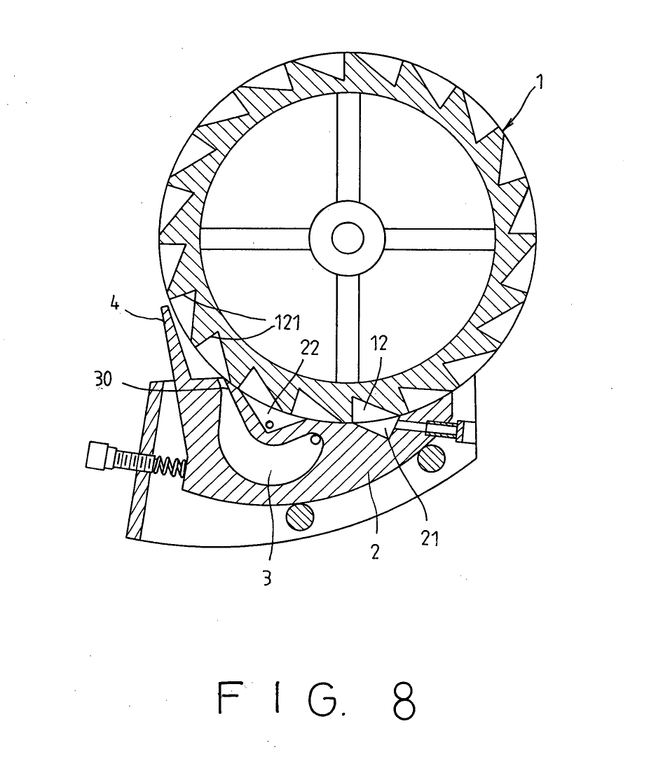

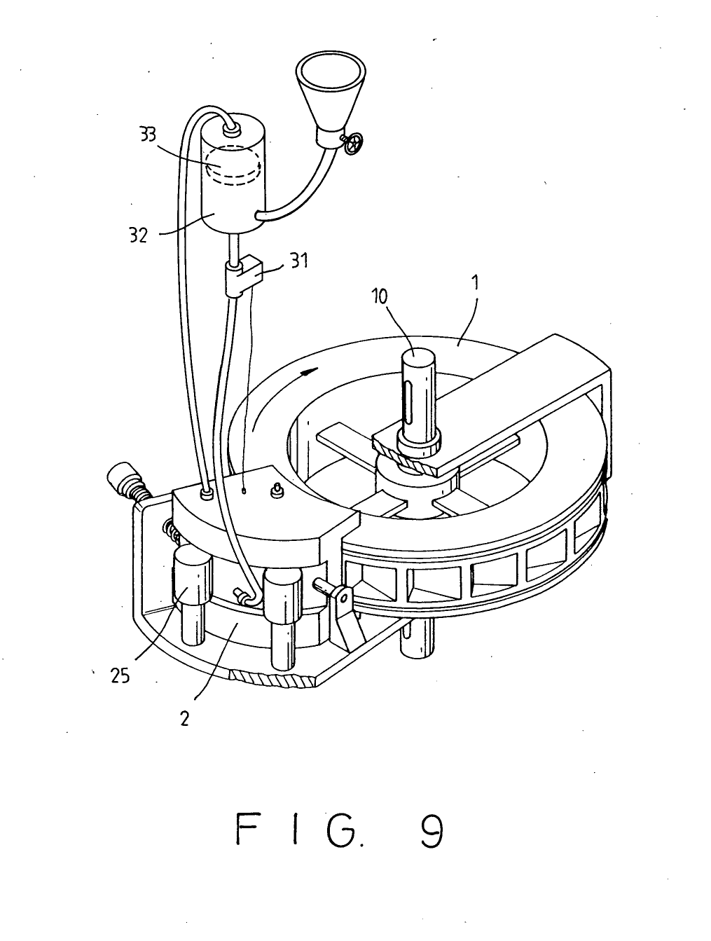

Please referring to FIGS. 8 and 9, it shows another modified embodiment of a rotary engine according to present invention, wherein the block (2) is provided with a cooling room (3) around the combustion chamber (22). A temperature controller (not shown) can be provided in the cooling room (3) for controlling an electrical valve (31) to spray water from a tank (32) into the cooling room (3) when the temperature in the cooling room (3) reaches to a presetting degree. A metal float (33) can be placed in the tank (32) floating on the water to provide enough pressure for spraying water into the room (3) as the valve (31) is opened. Then the cooling water becomes steam after cooling the combustion chamber (22) and the steam can be sprayed from its outlet vent (30) to push a relating leading plane of a pocket that facilitates the rotation of the wheel.

Moreover, a tail plate (4) is capable of being formed on the edge of the block (2). The pressured air is exhausted from the combustion chamber (22) and the related pocket (12) and it can be guided by the tail plate (4) to blow to the leading plane of another pocket that provides an added motive force for the wheel to rotate for increasing its output kinetic force.

In conclusion, the present invention discloses a rotary engine to get rid of the drawbacks resided in a conventional engine and to elevate the combustion temperature for increasing efficiency of the rotary engine that is novel and utilizable.

The embodiment described is only for illustrating the present invention, it will be apparent to those skilled in this art that various modifications or changes without departing from the spirit of this invention shall also fall within the scope of the appended claims.

I claim:

1. A rotary engine including a round wheel having a shaft pivoted on a frame to provide kinetic force during rotating, wherein the round wheel being provided with a plurality of axial pockets, each of which has a leading plane, and at least one block being located at a lateral side of the wheel being kept stable contact with the side surface of the wheel by use of elastic force provided by a spring mounted on a screw, and the block having an intake chamber and a combustion chamber, which are opposite to pockets of the wheel to form quasi cylinders; at least two rollers being fixed on the frame to support and maintain the block in stable, and an action force being produced when fuel is burn in the combustion chamber to push the wheel rotating for output kinetic force.

2. The rotary engine as claimed in claim 1, wherein the block is provided with a cooling room around the combustion chamber, a temperature controller is provided therein for controlling an electrical valve to spray water from a tank into the cooling room as the temperature in the room reaches to a presetting degree, and then the cooling water becomes steam after cooling the combustion chamber and is sprayed from its outlet vent to push a relating leading plane of a pocket that facilitates the rotation of the wheel.

3. The rotary engine as claimed in claim 1, wherein a tail plate is formed on the edge of the block to guide pressured air exhausted from the combustion chamber and the related pocket to blow to a leading plane of another pocket that provides an added motive force for the wheel to rotate for increasing its output kinetic force.

4. The rotary engine as claimed in claim 1, wherein the block is provided with a cooling room around the combustion chamber, a temperature controller is provided therein for controlling an electrical valve to spray water from a tank into the cooling room based on the temperature in the cooling room, and then the cooling water becomes steam after cooling the combustion chamber and is sprayed from its outlet vent to push a relating leading plane of a pocket; a tail plate is also formed on the edge of the block to guide pressured air exhausted from the combustion chamber and the related pocket to blow to a leading plane of another pocket that provides an added motive force for the wheel to rotate.
